(19) United States
(12) Patent Application Publication
(10) Pub. No.: US 2025/0388218 A1
(43) Pub. Date: Dec. 25, 2025

(54) DYNAMICALLY DETERMINING VEHICLE PITCH

(71) Applicant: Tesla, Inc., Austin, TX (US)

(72) Inventors: Harris Yong, Austin, TX (US); Edward Alley, Austin, TX (US)

(21) Appl. No.: 18/879,714

(22) PCT Filed: Jun. 29, 2023
(86) PCT No.: PCT/US2023/069432

§ 371 Date: Dec. 27, 2024

Related U.S. Application Data
(60) Provisional application No. 63/367,586, filed on Jul. 1, 2022.

(51) Int. Cl. B60W 40/11; B60Q 1/08

(52) U.S. Cl. CPC B60W 40/11; B60Q 1/08; B60W 2510/186; B60W 2520/105; B60W 2520/28

(57) ABSTRACT

A method for determining vehicle pitch comprising a first operational state, defined by the vehicle being above a velocity threshold, during which a plurality of inputs are used to determine absolute pitch. The pitch may be calculated by integrating the longitudinal acceleration measurements to estimate the distance-averaged global attitude of the longitudinal acceleration measurements, accounting for contributions from change in vehicle speed and average gravitational acceleration due to grade. The method further comprising a second operational state, defined by the vehicle being below a velocity threshold, during which a plurality of inputs are used to determine relative vehicle pitch.

### CROSS-REFERENCE TO RELATED APPLICATION

This application claims the benefit of U.S. Provisional Application No. 63/367,586, entitled “DYNAMICALLY DETERMINING VEHICLE PITCH”, and filed on Jul. 1, 2022, which is hereby incorporated by reference in its entirety.

### BACKGROUND

Generally described, a variety of vehicles, such as electric vehicles, combustion engine vehicles, hybrid vehicles, etc., can be configured with various control components that can be configured to facilitate operation. More specifically, vehicles may include one or more control components that utilize a measured or estimated vehicle pitch to adjust operation of the vehicle or otherwise set operational parameters associated with vehicle components. Illustratively, one such control component can include components that can cause the modification of the operation of headlights based on a measured or estimated vehicle pitch. Specifically, in one aspect, a control component can correspond to headlight leveling control that can modify the position of the vehicle headlights, such to maintain an angle of intersection of light relative to the plane of a road surface.

Vehicles can often include hardware and software functionality that facilitates location services or can access computing devices that provide location services. For example, a control component on a vehicle may be configured to determine an approximated location of the vehicle utilizing external information sources, such as global positioning system (“GPS”) sources, Wireless Local Area Networks (WLAN) access point information sources, Bluetooth information sources, radio-frequency identification (RFID) sources, and other location information available. Still further, vehicles can also include navigation systems or access navigation components that can generate information related to navigational or directional information provided to vehicle occupants and users.

### SUMMARY

In some aspects, the techniques described herein relate to a method for determining vehicle pitch for a plurality of vehicle operational states including: obtaining a first set of inputs corresponding to a first operational state of a vehicle, the first set of inputs corresponding to first operational information including positional information, longitudinal acceleration sensor information and at least one additional vehicle operational parameter; calculating absolute vehicle pitch based on the first operational information, wherein calculating the absolute vehicle pitch is based on at least two distinct positional measurements; storing the absolute vehicle pitch, determining that the vehicle is below a vehicle velocity threshold; obtaining a second set of inputs corresponding to a second operational state of the vehicle, the second set of inputs corresponding to second operational information including longitudinal acceleration sensor information; determining that the vehicle is characterized as likely to transition from the second operational state to the first operational state; obtaining a third set of inputs corresponding to a third operational state of the vehicle, the third set of inputs corresponding to third operational information including updated longitudinal acceleration sensor information; determine relative vehicle pitch change based on processing the second operational information and the third operational information; and storing the relative vehicle pitch change with the absolute vehicle pitch.

In some aspects, the techniques described herein relate to a method for determining vehicle pitch for a vehicle including: obtaining a first location sensor input corresponding to a first measurement of location; obtaining a first operational sensor input corresponding to the first measurement of location; obtaining a second location sensor input corresponding to a second measurement of location; obtaining a second operational sensor input corresponding to the second measurement of location; and determining a vehicle pitch based at least in part on the first location sensor input, the second location sensor input, the first operational sensor input, and the second operational sensor input.

In some aspects, the techniques described herein relate to a system for determining vehicle pitch for a vehicle, the system including: a GPS signal receiver; an accelerometer; a speed sensor; and a processing component configured to: receive a first elevation input corresponding to a first measurement of location from the GPS signal receiver; receive a first operational sensor input corresponding to the first measurement of location from the accelerometer and the speed sensor; receive a second elevation sensor input corresponding to a second measurement of location from the GPS signal receiver; receive a second operational sensor input corresponding to the second measurement of location from the accelerometer and the speed sensor; and determine the vehicle pitch based at least in part on the first elevation input, the second elevation input, the first operational sensor input, and the second operational sensor input.

### BRIEF DESCRIPTION OF THE DRAWINGS

These and other features, aspects and advantages of the present invention are described herein with reference to drawings of preferred embodiments, which are intended to illustrate, and not to limit, the present invention.

FIG. 1 depicts a block diagram of an illustrative an embodiment of an environment that corresponds to automatic determination of vehicle pitch;

FIG. 2 depicts an illustrative architecture for implementing the vehicle pitch processing component on one or more local resources or a network service;

FIG. 3A depicts a flow diagram of an embodiment of a pitch determination routine;

FIG. 3B depicts a flow diagram of an embodiment of a pitch determination routine;

FIG. 3C depicts an embodiment of a sub routine for dynamically calculating vehicle pitch; and

FIG. 4 depicts a flow diagram of an embodiment of a utilization of vehicle pitch information.

### DETAILED DESCRIPTION

Generally described, one or more aspects of the present disclosure relate to the configuration and dynamic calculation of vehicle pitch based in accordance with different operational states for a vehicle. By way of illustrative example, aspects of the present application relate to the utilization of inputs from various combinations of longitudinal acceleration sensing systems, location or navigation systems, or vehicle operational sensors to determine vehicle pitch dependent on the operational state of the vehicle. Illustratively, the dynamic calculation of vehicle pitch is determined without inputs from any physical measuring pitch, such as physical sensors that can measure and record vehicle pitch relative to a road plane.

In accordance with aspects of the present application, for operational parameters related to vehicle speeds above a threshold, a vehicle pitch processing component processes inputs from longitudinal acceleration sensing systems, location or navigation systems, and vehicle operational sensors measuring wheel speed, and other sensors/values to determine vehicle pitch. Other aspects of the present application for vehicle speed below a threshold in which locational processing information cannot be utilized to determine vehicle pitch, a vehicle pitch processing component processes inputs from acceleration sensing systems and vehicle operational sensors measuring and other sensors/values to determine changes in vehicle pitch based on previously determined vehicle pitch. By way of example, the acceleration sensing systems can include longitudinal acceleration systems. Accordingly, the vehicle pitch processing component can determine vehicle pitch for multiple operational states of the vehicle without need from a class of physical sensors, sensing systems or other components that directly measure suspension system displacement and used to determine vehicle pitch relative to road surfaces. Such class of physical sensors or sensing systems are often referred to as “ride height sensors”

Generally described, vehicle pitch can be utilized as inputs to control systems associated with vehicle. In one aspect, vehicle pitch can be inputs to control components associated with headlight leveling to maintain the angle of light provided from one or more headlight components of the vehicle relative to a current road surface. The control components can utilize motors or other control devices to adjust the headlight components (e.g., a vertical adjustment of at least a portion of the headlight components) based on vehicle pitch. In another aspect, vehicle pitch can be inputs to control components associated with or used to facilitate headlight aiming to establish vertical and horizontal angles/aim of light provided from one or more headlight components of the vehicle relative to a current road surface. Headlight aiming preferences/parameters may be set during manufacturing, prior to distribution, during vehicle servicing, or according to customer input/adjustments.

Traditionally, vehicles are associated with physical sensors that can measure vehicle pitch relative to the plane of the current road. Such physical sensors are typically configurable to determine vehicle pitch during operational states, including measurement of vehicle pitch while vehicles are substantially non-moving (e.g., below a velocity threshold), vehicles are moving (e.g., above a velocity threshold), or alternative definitions of movement. Nonetheless, physical sensor components correspond to additional costs for vehicle manufacture. Additionally, such physical sensors can be subject to failure, need for replacement, or upgrade. Additionally, a physical mounting of sensing system or sensor components may require customization according to the physical attributes of different makes, models or features of a vehicle.

As previously described, a vehicle may include a number of sensors, processing component and input sources that may have one or more functions. For example, navigation system and location systems may be configured for generation navigational or directional information. Vision systems may provide object detection that can assist with semi-automated driving functionality, automated driving functionality or safety systems. Such systems are not independently configured to provide such functionality associated with automated determination of vehicle pitch during operation of the vehicle above a speed threshold (e.g., a first operational state, also known as a drive cycle or a drive state), automated determination of vehicle pitch during operation of the vehicle below a speed threshold (e.g., a second operational state, also known as a parked cycle or parked state), or a combination thereof. Additionally, to the extent vision systems may be configured to attempt to determine vehicle pitch, such as systems are typically associated with high power consumption and poor accuracy in pitch estimation.

To address at least a portion of the above deficiencies, aspects of the present application correspond to utilization of a combined set of inputs from sensors or sensing systems, location systems and navigation systems that are integrated to determine vehicle pitch as a function of the sensor inputs. Aspects of the present application correspond to utilization of a combined set of inputs from sensors or sensing systems and location systems that are integrated to characterize events for determination of vehicle pitch above a speed threshold (e.g., a first operational state of the vehicle). The determined vehicle pitch can be considered to an absolute vehicle pitch. Such determination can further include automatic or automated processing or generation of control signals based on the determined vehicle pitch, such as activation of control components for leveling headlights.

Illustratively, a vehicle can include a vehicle pitch processing component that obtains and processes a set of inputs associated with the operation of a vehicle during the first operational state that include acceleration information (e.g., longitudinal acceleration value(s)), road grade information, and wheel speed information. Illustratively, the acceleration information is collected from an acceleration sensor or acceleration sensing system (e.g., a longitudinal acceleration sensor or longitudinal acceleration system). Additionally, the road grade information can illustratively be provided or calculated based on positioning and navigational system information, such as road grade based on known elevational information. Still further, the wheel speed information can be illustratively provided or calculated based on wheel speed sensing systems or sensors. In some embodiments, the longitudinal sensor(s), positioning and navigations system and wheel speed sensor(s) all correspond to components and functionality that has one or more other functions in the operation of the vehicle. As described herein, the vehicle pitch processing component calculates an absolute vehicle pitch value (or values) as a function from the set of inputs.

Other aspects of the present application correspond to utilization of a combined set of inputs from sensors or sensing systems and location systems that are integrated to characterize events for determination of vehicle pitch below a speed threshold (e.g., a second operational state of the vehicle). The determined vehicle pitch can be considered a relative vehicle pitch based on a previously determined absolute vehicle pitch during the first operational state of the vehicle. Such determination can further include automatic or automated processing or generation of control signals based on the determined vehicle pitch, such as activation of control components for leveling headlights.

Illustratively, a vehicle can include a vehicle pitch processing component that obtains and processes a set of inputs associated with the operation of a vehicle during the second operational state that include acceleration information (e.g., acceleration value(s)) and additional sensor(s) or sensor systems that may utilized as trigger events as described herein. As described above, the acceleration information is collected from a longitudinal sensor or sensing system. For purposes of the present application, the vehicle may be associated with any number of acceleration values measured during operation. Accordingly, reference to acceleration information may be associated with selection of one or more instances of measured acceleration information. Such collected information may be generally referred to as “first,” “second” . . . for purposes of clarifying the number of measured values or a plurality of measured acceleration values. The vehicle pitch processing component can associate the last absolute vehicle pitch with the second longitudinal acceleration value(s) when the vehicle enters into the second operational state. Thereafter, when the vehicle pitch processing components processes sensor inputs or otherwise receives information corresponding to a trigger event characterizing that the vehicle may be resuming the first operational state (e.g., exceeding the speed threshold, activation of the propulsion systems, detected movement, locking of doors, etc.), the vehicle pitch processing component obtains updated acceleration values (e.g., third longitudinal acceleration values) measured at the time of the trigger event. The vehicle pitch processing component can then determine a change in vehicle pitch based on processing the first and second longitudinal acceleration values.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicles including vehicles with different of propulsion systems, such as combination engines, hybrid engines, electric engines, and the like. Still further, aspects of the present application may be applicable with various types of vehicles that can incorporate different types of sensors, sensing systems, navigation systems, or location systems. For example, in some embodiment, aspects of the present application may be implemented without any inputs from navigation systems. Similarly, aspects of the present application may be combined with or implemented with other types of components that may facilitate operation of the vehicle, including autonomous driving applications, driver convenience applications and the like.

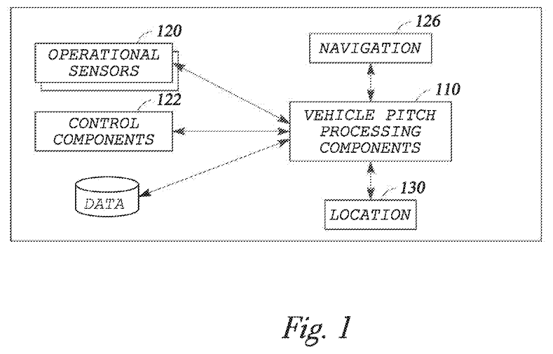

FIG. 1 illustrates an environment that corresponds to automatic determination of vehicle pitch in accordance with one or more aspects of the present application. The environment includes a collection of local sensor inputs that may be utilized to allow a vehicle pitch processing component 110 to automatically determine vehicle pitch during various operational states of a vehicle, such as operational states characterized or defined by speed thresholds. The collection of local sensors 120 can include one or more sensor or sensor-based systems included with a vehicle or otherwise accessible by a vehicle during operation. The local sensors 120 or sensor systems 120 may be integrated into the vehicle. Alternatively, the local sensors or sensor systems may be provided by interfaces associated with a vehicle, such as physical connections, wireless connections, or a combination thereof.

In one aspect, the local sensors can include one or more positioning systems that can obtain reference information from external sources that allow for various levels of accuracy in determining positioning information for a vehicle. For example, the positioning systems can include various hardware and software components for processing information from various sources. Illustrative examples include, but are not limited to, information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes including self-driving applications, enhanced driving or user-assisted navigation, and the like. Illustratively, the positioning systems can include processing components and data 124 that facilitate the identification of various vehicle parameters as described herein.

In still another aspect, the local sensors can include one or more navigations system for identifying navigation related information. Illustratively, the navigation systems can obtain positioning information from positioning systems and identify characteristics or information about the identified location, such as elevation, road grade, etc. The navigation system or other vehicle systems may further obtain elevation information by looking up or comparing location information to known elevation information associated with maps or database. The navigation systems can also identify suggested or intended lane location in a multi-lane road based on directions that are being provided or anticipated for a vehicle user. Similar to the location systems 130, the navigation system 126 may be configured as part of a vehicle for multiple purposes including self-driving applications, enhanced driving or user-assisted navigation, and the like. The navigation systems may be combined or integrated with positioning systems, illustratively, the navigation systems can include processing components and data that facilitate the identification of various vehicle parameters as described herein. As previously identified, in some embodiments, inputs from navigation system may be omitted or not otherwise utilized.

The local resources further include a vehicle pitch processing component that may be hosted on the vehicle or a computing device accessible by a vehicle (e.g., a mobile computing device). The vehicle pitch processing component can illustratively access inputs from various local sensors or sensor systems and process the inputted data as described herein. The vehicle pitch processing component can illustratively process inputs from a combination of positioning systems, navigation systems, and other vehicle operational parameters to dynamically calculate vehicle pitch during multiple operational states of the vehicle. More specifically, the vehicle pitch processing component can determine vehicle pitch as a function of sensor inputs during a first operational state associate corresponding to vehicle velocity above a threshold. The velocity threshold can correspond to vehicle velocities above a minimal velocity and for a minimal amount of time that can be characterized as a sustained state of vehicle motion sufficient for utilization of positional information. The minimal velocity threshold and time threshold can be dynamically determined based on criteria, such as positional signal availability (e.g., GPS signal strength), historical information, and the like. The vehicle pitch processing component can determine vehicle pitch as a function of sensor inputs during a second operational state associate corresponding, to vehicle velocity below the threshold. In this embodiment, some prior approach vehicle pitch determination methods based on positional and navigational information may not be available.

The environment can further include various additional sensor components or sensing systems operable to provide information regarding various operational parameters of the vehicle for use in determination of vehicle pitch in accordance with one or more of the operational states. Illustratively, in one embodiment, the additional sensor components can include sensors for measuring or determining longitudinal acceleration of the vehicle. The longitudinal acceleration input may be utilized to determine vehicle pitch during the first and second operational states as discussed herein. In another embodiment, the additional sensor components can include sensors for measuring or determining wheel speed for use in determining vehicle pitch during a first operational state. In another embodiment, the additional sensor components can include sensor for measuring or determining when a vehicle may be transitioning from the second operational state to the first operational state, such as transmission status, ignition status, fastening of safety belts, parking brake status, selection of navigational destination, audible inputs, status of latches/locks associated with doors, trunks, or other entry points, and the like. Transmission status may be understood to be information related to whether the vehicle is in park, drive, or reverse. Transmission status does not require a transmission component as some electric vehicle do no require a transmission but still have a park, drive, and reverse status. Ignition status may be understood to be whether the vehicle is off, in an on state but not a drive state, or whether the vehicle is on and running, where running is associated with a drive or reverse transmission status. A door status may comprise the status of latches/locks associated with doors, trunks, or other entry points. A door status may be information such as door, trunk, or lid is open or closed. It should be understood that sensors associated with status determination may be individual sensors or sensors integrated into various components associated with a component of each status, such as a latch or lock function of a vehicle door being used to determine the door is in the closed state. Further, there need not be any specific sensor associated with a status sensor, as it should be understood that other components may determine a status, for example of the transmission.

The environment can further include one or more control components 122 for processing outputs from the vehicle pitch processing component 110. In one embodiment, the control components 122 can include control components for headlight leveling functionality based, at least in part, on outputs from the vehicle pitch processing component. In another embodiment, the control components 122 can include control components for headlight aiming functionality, based at least in part, on outputs from the vehicle pitch processing component. Other embodiments of control components 122 can include, but are not limited to, suspension control components, collision avoidance components, and the like. As previously described, illustratively, headlight leveling can be utilized to maintain the angle of light provided from one or more headlight components of the vehicle relative to a current road surface. The control components 122 can utilize motors or other control devices to adjust the headlight components (e.g., a vertical adjustment of at least a portion of the headlight components) based on vehicle pitch. As also previously described, headlight aiming can be utilized to establish vertical and horizontal angles/aim of light provided from one or more headlight components of the vehicle relative to a current road surface. Headlight aiming preferences/parameters may be set during manufacturing, prior to distribution, during vehicle servicing, or according to customer input/adjustments.

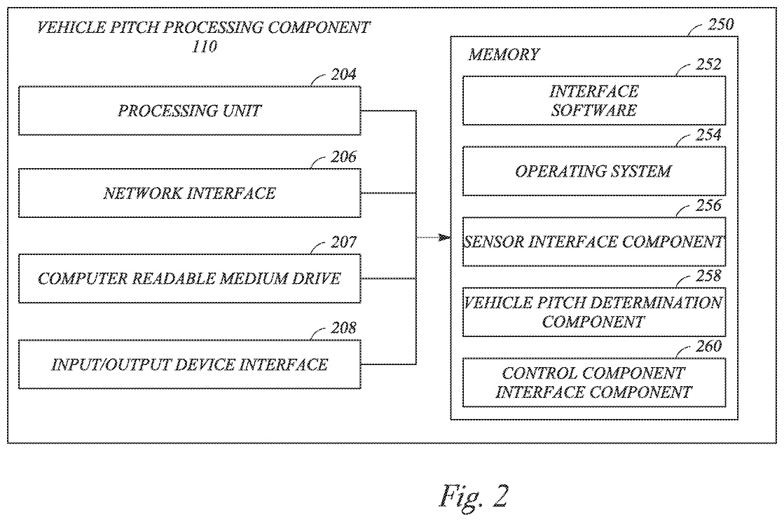

With reference now to FIG. 2, an illustrative architecture for implementing the vehicle pitch processing component on one or more local resources or a network service will be described. The vehicle pitch processing component may be part of components/systems that provide functionality associated with the operation of headlight components, suspension components, etc. In other embodiments, the vehicle pitch processing component may be a stand-alone application that interacts with other components, such as a local sensors or sensor systems, signal interfaces, etc.

The architecture of FIG. 2 is illustrative in nature and should not be construed as requiring any specific hardware or software configuration for the vehicle pitch processing component. The general architecture of the vehicle pitch processing component 110 depicted in FIG. 2 includes an arrangement of computer hardware and software components that may be used to implement aspects of the present disclosure. As illustrated, the vehicle pitch processing component 110 can be implemented in a computing environment including a processing unit 204, a network interface 206, a computer readable medium drive 207, and an input/output device interface 208, all of which may communicate with one another by way of a communication bus. The components of the vehicle pitch processing component 110 may be physical hardware components or implemented in a virtualized environment. Additionally, in other embodiments, the vehicle pitch processing component 110 can be executed in embedded systems or specialized components, such as microcontrollers, embedded control units, and the like.

The network interface 206 may provide connectivity to one or more networks or computing systems, such as the network of FIG. 1. The processing unit 204 may thus receive information and instructions from other computing systems or services via a network. The processing unit 204 may also communicate to and from memory 250 and further provide output information for an optional display via the input/output device interface 208. In some embodiments, the vehicle pitch processing component 110 may include more (or fewer) components than those shown in FIG. 2, such as implemented in a mobile device or vehicle.

The memory 250 may include computer program instructions that the processing unit 204 executes in order to implement one or more embodiments. The memory 250 generally includes RAM, ROM, flash memory, Ni/RAM, or other persistent or non-transitory memory. The memory 250 may store interface software 252 and store an operating system 254 that provides computer program instructions for use by the processing unit 204 in the general administration and operation of the vehicle pitch processing component 110. The memory may further include computer program instructions and other information for implementing aspects of the present disclosure. For example, in one embodiment, the memory includes a sensor interface component 256 that obtains information from various sensors or sensing systems, such as navigational systems, positional systems, vehicle operational parameter systems, and the like. The memory further includes a pitch determination component 258 for utilizing the sensor input to determine vehicle pitch in accordance with various operational states of the vehicle as described herein. Illustratively, the vehicle pitch determination component 258 can be configured to determine vehicle pitch according to different operating states of the vehicle including a first operating state corresponds to vehicle velocity above a threshold based on exceeding a minimal velocity for a minimal amount of time. Illustratively, the second operational state corresponds to vehicle velocity below the threshold. The memory can further include a control component interface 260 for providing outputs to various control components that may utilize vehicle pitch as inputs. Although illustrated as components combined within the vehicle pitch processing component 110, one skilled in the relevant art will understand that one or more of the components in memory may be implemented in individualized computing environments, including both physical and virtualized computing environments.

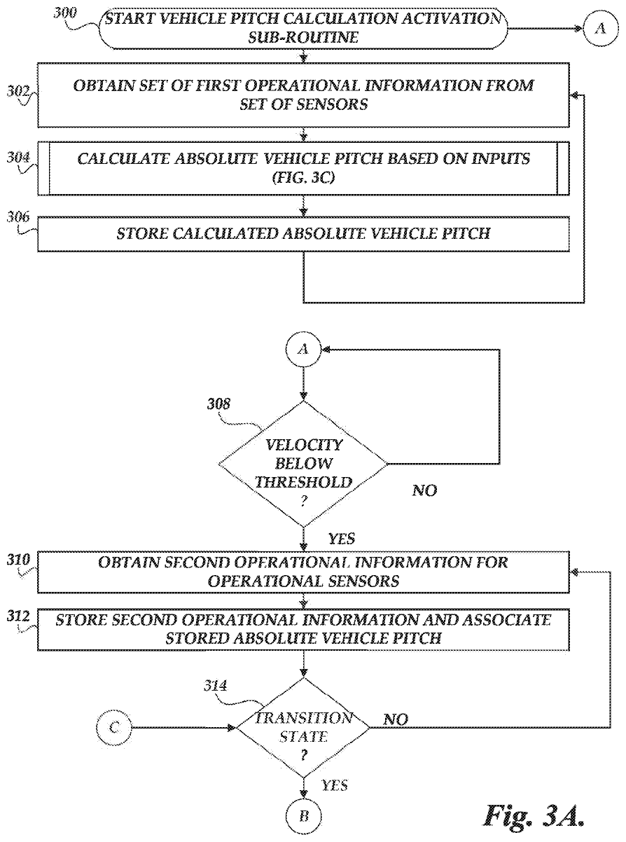

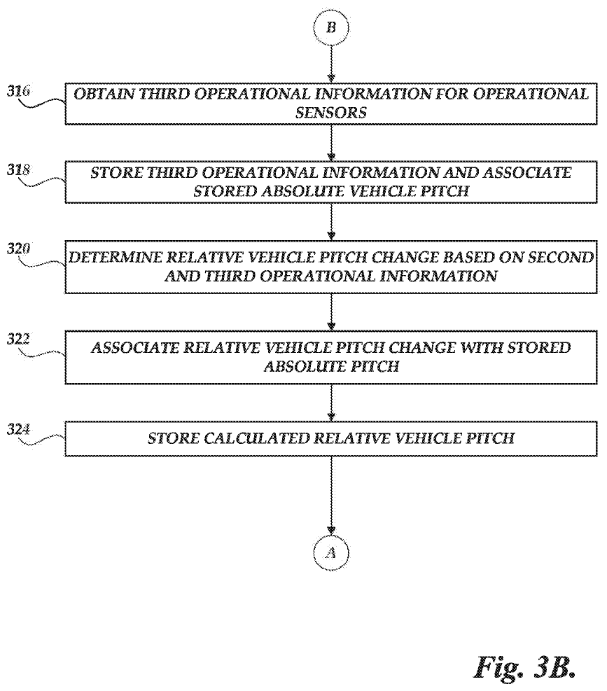

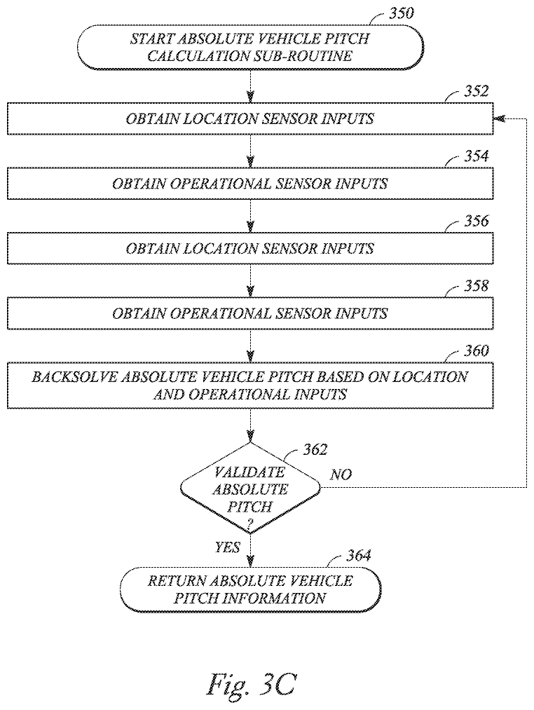

Turning now to FIGS. 3A-3C, a flow diagram of a pitch determination routine 300 and associated sub-routine 350 implemented by a vehicle pitch processing component will be described. Illustratively, pitch determination routine 300 represent a general routine for determining vehicle pitch in two or more operational states. Illustratively, the first operational state corresponds to vehicle velocity above a threshold based on exceeding a minimal velocity for a minimal amount of time. Illustratively, the second operational state corresponds to vehicle velocity below the threshold (above). For purposes of illustration, routine 300 will attempt to process vehicle pitch based on the first operational state in parallel with processing vehicle pitch based on the second operational state. The results of the processing along the parallel tracks will vary based on the current operational state of the vehicle (as described herein). Illustratively, operational state of a vehicle and reference to “first” and “second” operational states are intended illustratively for distinguishing between two or more scenarios in which one or more measured parameters are different, such as vehicle velocity.

With consideration first to processing of the sensor inputs according to the first operational state, blocks 302-306 will be described. At block 302, the vehicle pitch processing component obtains vehicle operational inputs. As described above, in an illustrative embodiment, the vehicle pitch processing component can process inputs from a combination of positioning and vehicle operational parameters corresponding to wheel speed. In another aspect, inputs can be provided by (or requested from) one or more positioning systems that can obtain reference information from external sources that allow for various levels of accuracy in determining positioning information for a vehicle. For example, the positioning systems can include various hardware and software components for processing information from GPS sources, illustratively. In some embodiments, information from the positioning systems can be obtained as combinations of information from multiple sources. Illustratively, the positioning systems can obtain information from various input sources and determine positioning information for a vehicle. In other embodiments, the positioning systems can also determine travel-related operational parameters, such as direction of travel, velocity, acceleration, and the like.

In still another aspect, in some embodiments, inputs can be provided by (or requested by) one or more navigations system for identifying navigation related information. Illustratively, the navigation systems can obtain positioning information from positioning systems and identify characteristics or information about the identified location. For example, the navigation systems can identify current characteristics of the road, such as anticipated lane mergers, lane splits, turning lanes, etc. based on configured information. The navigation systems can also identify suggested or intended lane location in a multi-lane road based on directions that are being provided or anticipated for a vehicle user. As previously described, information from navigation systems can be omitted, ignored or otherwise not utilized.

At block 304, the vehicle pitch processing component calculates or determines absolute vehicle pitch as a function of the collected navigational, positional and operational parameters. Illustratively, the vehicle pitch processing component can implement an absolute pitch calculation sub-routine, which will be described with regard to FIG. 3C.

Prior to description of an illustrative absolute pitch calculation sub-routine, a general description of the dynamic calculation of vehicle pitch during the first operational state will be described. One skilled in the relevant art will appreciate that one of various algorithms or methodologies may be implemented to determine absolute vehicle pitch based on collected navigational, positional and operational parameters. One example of such an approach is disclosed in U.S. Pat. No. 6,714,851, entitled Method For Road Grade/Vehicle Pitch Estimation, and filed on Jan. 7, 2002, which is hereby incorporated by reference in its entirety. Another example of such an approach is disclosed in Henrik Jansson, Ermin Kozica, Karl Henrik Johansson, “A Sensor And Data Fusion Algorithm For Road Grade Estimation” 5th IFAC Symposium on Advances in Automotive Control (2007), which is also incorporated by reference herein. Any number of additional or alternative specific algorithms, generally referred to as fusion algorithms, for estimating road grade may be utilized.

Turning now to FIG. 3C, an illustrative sub-routine 350 for dynamically calculating vehicle pitch based on a first operational state of a vehicle will be described. Illustratively, sub-routine 350 corresponds to a fusion algorithm that facilitates the determination of vehicle pitch based on elevation information of the vehicle and additional vehicle operational parameters. Illustratively, sub-routine 350 only requires a minimum of two sets of input data to make a vehicle pitch determination and does not require continuous monitoring or processing of vehicle operational data. Prior to initiating sub-routine 350, the vehicle pitch processing component may process vehicle operational inputs or make a determination of whether the vehicle pitch processing component will be able to obtain the necessary inputs and whether the loads on the vehicle are sufficiently stable to calculate vehicle pitch (e.g., vehicle loading is complete). For example, the vehicle pitch processing component can determine whether positional information sensors are operational and receiving location information signals (e.g., GPS signals). In another example, the vehicle pitch processing component can determine whether the accelerometer sensors and speed sensors are operational and generating signals. In still another example, the vehicle pitch processing component can determine indications of vehicle loading completion, such as whether all the doors are closed, safety belts are buckled, vehicle transmission engaged, etc. In still further examples, the vehicle pitch processing component can determine whether specific requirements regarding vehicle operational status that may not be optimized for vehicle pitch determination are present, including but not limited to, transportation of the vehicle, servicing/testing of the vehicle, operating the vehicle in reverse, and the like. In such examples, the vehicle pitch processing component can determine whether to delay the implementation of the sub-routine 350, cancel the implementation of the sub-routine, modify the implementation of the sub-routine, and the like.

At block 352, the vehicle pitch processing component obtains location sensor inputs corresponding to a first measurement of location. Illustratively, the location sensor inputs can correspond to a specific of elevational information based on a current location of the vehicle. Such elevational information can be included in signals received from the location service components, such as GPS signal information that can be received at the vehicle. The elevational information can be based on one or more different reference points. Additionally, the location service components may provide multiple types/forms of elevational information that can be selected by the vehicle pitch processing component.

At block 354, the vehicle pitch processing component obtains operational sensor inputs corresponding the same first measured location. Illustratively, the operational sensor inputs can include timing information, vehicle velocity information, and acceleration measurements. The acceleration measurements may be collected and stored continuously. In some embodiments, the acceleration values (e.g., A) can be further processed to increase accuracy in cases where the sensor measurement is noisy or loading/movement of the vehicle is actively taking place.

On the assumption that the vehicle has not stopped and is continuously in motion, at block 356, the vehicle pitch processing component obtains additional location sensor inputs corresponding to a selection of at least one additional point of measurement. In this regard, the second location and operational inputs can be selected from a set of inputs that have been continuously measured and collected. For example, a second set of inputs can be selected based on exceeding a minimal travel threshold. As described above, the location sensor inputs can correspond to a specific of elevational information based on a current location of the vehicle (e.g., the second location). For purposes of sub-routine 350, the vehicle pitch processing component will attempt to collect or define the elevational information in accordance with the same common reference point or calculation process utilized in the first sensor information (block 352). This facilitates comparison between two or more collected values.

At block 358, the vehicle pitch processing component obtains second operational sensor inputs. Illustratively, the operational sensor inputs can include second timing information, second vehicle velocity information, and the longitudinal acceleration measurements. As previously described, the longitudinal acceleration measurements may be collected and stored continuously.

At block 360, the vehicle pitch processing component back solves the absolute vehicle pitch based on the two sets of location sensor and operational sensor information. Illustratively, block 360 corresponds to the integration of the longitudinal acceleration measurements to estimate the distance-averaged global attitude of the longitudinal acceleration measurements. The vehicle pitch processing component can further remove the effect of changes in velocity contributions of the wheels and the average gravitational force for the grade.

Equation 1 defines such an illustrative back solving technique as:

$${pitch}_{vehicle} = {sin}^{- 1} ( \frac{{\int }_{1}^{2} {A}_{x} ds - \frac{1}{2} ( {v}_{2}^{2} - {v}_{1}^{2} )}{g s} ) - {tan}^{- 1} ( \frac{{Elevation}_{2} - {Elevation}_{1}}{s} )$$

Illustratively, the longitudinal acceleration measurements (Aₓ) can be processed such that any compensation or processing can be removed (e.g., uncompensated). As described above, the two elevation measurements (Elevation₂ and Elevation₁) can also be processed to have a common reference point or to select a common reference point that may have the least amount of error based on the distance between the two measurements. Illustratively, the locations during a drive when the first and elevation measurements are taken, and the enclosing period when the line integral calculation is performed, can be delayed or advanced to optimize according to conditions such as GPS elevation accuracy.

At decision block 362, a test is conducted to determine whether to validate the calculated absolute vehicle pitch. Illustratively, the vehicle pitch processing component can ensure that the determined/calculated vehicle pitch information may not be erroneous or be characterized as otherwise unreliable. In one example, if the vehicle pitch processing component determines that doors were opened or the vehicle shifts transmission status (e.g., reverse), the vehicle pitch processing component can consider the vehicle pitch calculation as unreliable. In another example, the vehicle pitch processing component can compare the determined/calculated vehicle pitch against historical values of vehicle pitch to determine of confidence factor related to whether the determine vehicle pitch is within an acceptable range of values based on previous determinations/calculations. In still another example, the vehicle pitch processing component can periodically update the routine by causing a recalculation of the vehicle pitch based on different location service measurements to mitigate against potential intermittent disruptions of location service signals. In still further examples, the vehicle pitch processing component can utilize inputs from other sensors, such as weight sensors, engine torque, etc. to validate whether the calculated vehicle pitch would be consistent with expected values of vehicle weight measurements or torque produced by the vehicle to cause the vehicle propulsion. In such embodiments, the vehicle pitch processing component can utilize historical vehicle pitch or default values. The vehicle pitch processing component can utilize a plausibility monitor to validate the vehicle pitch at decision block 362. A plausibility monitor can analyze inputs or calculated values to validate the vehicle pitch or reject the determined vehicle pitch. The plausibility monitor may compare the determined vehicle pitch with calculated vehicle pitch limits, which are calculated based on gross vehicle weight rating and known suspension spring rates, rejecting the vehicle pitch value if it falls outside of the limits. The plausibility monitor may reject a vehicle pitch value if the calculated average vehicle speed between the GPS sampling points is beyond the capable top speed of the vehicle. The plausibility monitor may reject a vehicle pitch value if the calculated average grade between the GPS sampling points is implausibly steep for the vehicle to climb successfully. The plausibility monitor may reject a vehicle pitch value if the calculated average motor power between the GPS sampling points is implausibly high (beyond the capability of the vehicle powertrain). The plausibility monitor may reject a vehicle pitch value if it suggests very nose down but the independent mass estimate suggests the car is very heavily laden. The plausibility monitor may reject a vehicle pitch value if it suggests very nose up but the independent mass estimate suggests the car is very lightly laden. In another embodiments, the vehicle pitch processing component can repeat one or more portions of sub-routine 350 for an updated calculation. It should further be understood that validating vehicle pitch may be used to validation absolute vehicle pitch or other forms of vehicle pitch such as relative vehicle pitch. At block 364, the sub-routine terminates with the return of the calculated absolute vehicle pitch.

Returning to FIG. 3A, at block 306, the vehicle pitch processing component stores the determined vehicle pitch as an absolute vehicle pitch. Illustratively, the control components may utilize the stored vehicle pitch as inputs to various processing, such as headlight leveling. Some control components, however, may be disable, such as headlight aiming during the first operational state. Additionally, in some specific embodiments, such as during transportation, towing or specific scenarios, the vehicle pitch information may be invalidated or otherwise made unavailable. Additionally, as will be explained further, the stored absolute vehicle pitch information may be utilized to determine relative vehicle pitch when the vehicle is in a second operational state.

Illustratively, in some embodiments, the vehicle does not need to continuously determine vehicle pitch when the vehicle is in the first operational state. Accordingly, a measurement of vehicle pitch during the first operational state may be valid for a period of time in which navigational or positional information may be unavailable to the vehicle or otherwise not considered valid (e.g., GPS signals may be unavailable or unreliable). Additionally, the vehicle pitch processing component may also be configured to periodically calculate vehicle pitch during intervals or upon satisfaction of various criteria. This may provide for further efficiencies related to power management or power conservation.

At decision block 308, a test is conducted to determine whether the vehicle can be characterized as having a stable orientation with respect to earth's gravitational field for purposes for determining vehicle pitch. Illustratively, situations in which a vehicle has dropped below a vehicle speed threshold can be considered sufficient to make such characterizations. Illustratively, the vehicle speed threshold can correspond to a minimum vehicle speed in which the determination of vehicle pitch using navigational and positional information may be not available. Such vehicle speed can be characterized as when a vehicle is approaching a stopping position. If the vehicle speed is not below the threshold, the routine 300 returns to “A”. Alternatively, if the vehicle speed is below the threshold, the routine 300 continues to block 310. In other embodiments, alternative or additional criteria may be considered as part of characterizations.

Beginning with block 310, the routine 300 will process information attributable or associated with dynamic determination of vehicle pitch during a second operational state (e.g., vehicle speed below the threshold). Illustratively, the second operational state can be characterized as a state in which the vehicle grade will remain the same because the vehicle is not in motion and in which the vehicle pitch may vary based on changes to operational parameters of the vehicle, changes in loading, changes in passengers, and the like. Illustratively, vehicle pitch in the second operation state can be determined based on Equation (2):

$$RoadGrade + VehiclePitch = arc sin ( \frac{{A}_{x}}{g} )$$

In one approach, RoadGrade information may be provided based on the navigational information for the current position. Longitudinal acceleration (Aₓ) may be provided based on outputs from the longitudinal acceleration component of the vehicle. The longitudinal acceleration can be further processed to remove the contribution of the vehicle wheels, accounted for by the inputted wheel speed data. The acceleration of gravity (g) may be predefined. In another approach, RoadGrade information does not need to be solved for, because 2 instances of this equation are compared while the vehicle is stationary on the same road surface, providing the ability to calculate a difference in vehicle pitch across two measurements of Aₓ. At block 310, the vehicle pitch processing component obtains second vehicle operational inputs (e.g., relative to the first operational inputs obtained at block 302). As described above, in an illustrative embodiment, the vehicle pitch processing component can process inputs from vehicle operational components, namely, the acceleration sensor. At block 312, the vehicle pitch processing components stores the second operational information and associates the stored operational inputs with the previously calculated and stored absolute vehicle pitch information.

At decision block 314, the vehicle pitch processing component the determines whether the vehicle can be characterized as remaining in the second operational state. Illustratively, the determination and characterization can be based on various operational parameters, such as identifying the ingress or egress of passengers, identifying the operation of storage areas (e.g., trunk space or storage compartments), monitoring the transmission status of the vehicle (park vs. drive or reverse), identifying activation of the navigational components, identifying activation of different power modes, detecting release of charging systems, and the like. At decision block 314, the vehicle pitch processing component may determine whether the vehicle is characterized as likely to transition from the second operational state to the first operational state. This may be determined based on the operational parameters discussed above. For example the vehicle may be characterized as likely to transition from the second operation status to the first operational status when all the vehicle doors, trunks, or lids are closed. Block 314 will loop to block 310 for as long as the vehicle remains in the second operational state.

Referring to FIG. 3B, at decision block 316, the vehicle pitch processing component has determined that the vehicle can no longer be characterized as remaining in the second operational state and is likely transitioning to the first operational state and the vehicle pitch processing component obtains additional vehicle operational inputs (e.g., acceleration measurements) relative to the first operational inputs obtained at block 302 and the second operational inputs obtained at block 310). Illustratively, the specific triggers by which the additional vehicle operational inputs are collected can be varied, such as speed thresholds, change in transmission status, door/opening latch status and the like. At decision block 316 the vehicle pitch processing component obtains third set of inputs (which may be operational inputs) corresponding to a third operational state. It should be understood that a third operational state may correspond to the determination that the vehicle can no longer be characterized as remaining in the second operational state and is likely transitioning to the first operational state. At block 318, the vehicle pitch processing component stores the third operational information.

At block 320, the vehicle pitch processing component utilizes the changes in the second and third operational inputs to determine a relative change in vehicle pitch. In this aspect, because the vehicle is in the second operational state, the RoadGrade variable in equation (1) remains constant in virtual pitch calculations involving the second and third operational parameters. Accordingly, a comparison of change in readings from the longitudinal acceleration sensor can be attributable to changes in the vehicle pitch as the vehicle is not otherwise in motion. At block 322, the vehicle pitch processing component associates the determined change in operational information with the previously stored absolute vehicle pitch and stores that value as the vehicle pitch information, such as for use by control components. At block 324, the vehicle pitch processing component stores the relative vehicle pitch. The routine 300 returns to decision block 308.

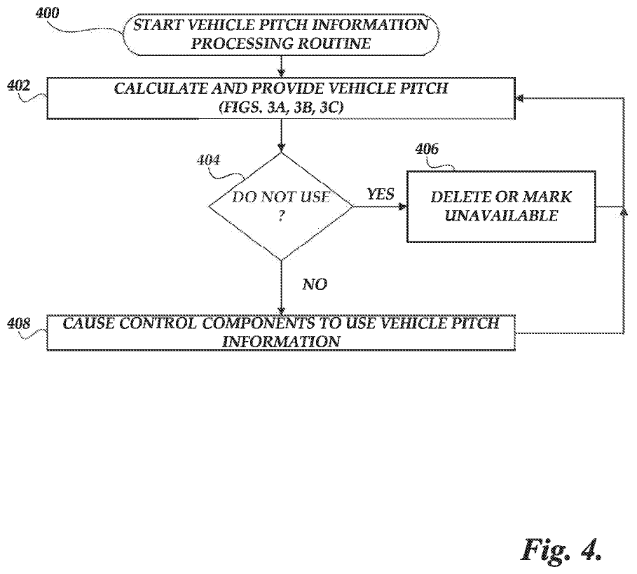

Turning now to FIG. 4, a routine 400 for utilization of vehicle pitch information will be described. As described above, the vehicle pitch processing component may provide the determined vehicle pitch information to the control components for operation. At block 402, the vehicle pitch processing component provides or makes available vehicle pitch information. Illustratively, the vehicle pitch information can correspond to either the absolute vehicle pitch information determined in routine 300 or the relative vehicle pitch information determined in routine 300 based on the operational state of the vehicle.

At decision block 404, a test is conducted to determine whether to further process, manage, or prevent use of the vehicle pitch information. As described above, in some specific embodiments, such as during transportation, towing or specific scenarios, the vehicle pitch information vehicle pitch processing component may be invalidated or otherwise made unavailable. If the vehicle pitch information is to be further processed, managed, or otherwise prevented, at block 406 the vehicle pitch processing component can delete or mark the vehicle pitch information as unavailable. In other embodiments, the vehicle pitch processing component can use default or historical information. Alternatively, at block 408, the control components can utilize the vehicle pitch information as described herein. As described above, in one embodiment, the control components can include control components for headlight leveling functionality based, at least in part, on outputs from the vehicle pitch processing component. In another embodiment, the control components can include control components for headlight aiming functionality, based at least in part, on outputs from the vehicle pitch processing component. Other embodiments of control components can include, but are not limited to, suspension control components, collision avoidance components, and the like. Routine 400 returns to block 402.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control algorithms. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer those two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A method for determining vehicle pitch for a plurality of vehicle operational states comprising:
obtaining a first set of inputs corresponding to a first operational state of a vehicle, the first set of inputs corresponding to first operational information including positional information, longitudinal acceleration sensor information and at least one additional vehicle operational parameter;
calculating absolute vehicle pitch based on the first operational information, wherein calculating the absolute vehicle pitch is based on at least two distinct positional measurements;
storing the absolute vehicle pitch;
determining that the vehicle has transitioned to a second operational state;
obtaining a second set of inputs corresponding to a second operational state of the vehicle, the second set of inputs corresponding to second operational information including longitudinal acceleration sensor information;
determining that the vehicle is characterized as likely to transition from the second operational state to the first operational state;
obtaining a third set of inputs corresponding to a third operational state of the vehicle, the third set of inputs corresponding to third operational information including updated longitudinal acceleration sensor information;
determine relative vehicle pitch change based on processing the second operational information and the third operational information; and
storing the relative vehicle pitch change with the absolute vehicle pitch.

2. The method of claim 1, further comprising causing control of a vehicle component based on the relative vehicle pitch change or the absolute vehicle pitch.

3. The method of claim 2, wherein the vehicle component comprises a headlight leveling component configured to level headlights based on the relative vehicle pitch change or the absolute vehicle pitch.

4. The method of claim 1, wherein the at least one additional vehicle operational parameter comprises vehicle velocity information.

5. The method of claim 1, wherein determining that the vehicle is characterized as likely to transition from the second operational state to the first operational state comprises determining that all vehicle doors have been shut.

6. The method of claim 1, wherein the positional information comprises elevation information.

7. The method of claim 1, wherein determining that the vehicle has transitioned to a second operational state comprises analyzing a vehicle door status, a parking brake status, a transmission status, an ignition status, or vehicle speed.

8. A method for determining vehicle pitch for a vehicle that operates at least in a first operational state and a second operational state, the method comprising:
obtaining a first location sensor input corresponding to a first measurement of location;
obtaining a first operational sensor input corresponding to the first measurement of location;
obtaining a second location sensor input corresponding to a second measurement of location;
obtaining a second operational sensor input corresponding to the second measurement of location;
determining a vehicle pitch based at least in part on the first location sensor input, the second location sensor input, the first operational sensor input, and the second operational sensor input that correspond to the first operational state;
determining that the vehicle has transitioned to the second operational state;
obtaining a set of inputs corresponding to the second operational state, the set of inputs comprising operational information including positional information or longitudinal acceleration sensor information associated with the second operational state; and
storing at least a portion of the set of inputs and the vehicle pitch for further processing.

9. The method of claim 8, further comprising validating the vehicle pitch.

10. The method of claim 8, wherein the method comprises continuously obtaining location sensor inputs that comprise the first location sensor input and the second location sensor input, or continuously obtaining operational sensor inputs that comprise the first operational sensor input and the second operational sensor input.

11. The method of claim 8, wherein the first location sensor input and the second location sensor input correspond to specific elevational information.

12. The method of claim 8, wherein the first operational sensor input corresponds to timing information, vehicle velocity information, and acceleration measurements.

13. The method of claim 8, further comprising actuating a vehicle component based on the vehicle pitch.

14. The method of claim 13, wherein the vehicle component comprises a headlight leveling component configured to level headlights based on the vehicle pitch.

15. The method of claim 8, further comprising facilitating aiming of headlights with the vehicle pitch.

16. A system for determining vehicle pitch for a vehicle that operates at least in a first operational state and a second operational state, the system comprising:
a GPS signal receiver;
an accelerometer;
a speed sensor; and
a processing component configured to:
receive a first elevation input corresponding to a first measurement of location from the GPS signal receiver;
receive a first operational sensor input corresponding to the first measurement of location from the accelerometer and the speed sensor;
receive a second elevation input corresponding to a second measurement of location from the GPS signal receiver;
receive a second operational sensor input corresponding to the second measurement of location from the accelerometer and the speed sensor;
determine the vehicle pitch based at least in part on the first elevation input, the second elevation input, the first operational sensor input, and the second operational sensor input that correspond to the first operational state;
determine that the vehicle has transitioned to the second operational state;
obtain a set of inputs corresponding to the second operational state, the set of inputs comprising operational information including positional information or longitudinal acceleration sensor information associated with the second operational state; and
store at least a portion of the set of inputs and the vehicle pitch for further processing.

17. The system of claim 16, further comprising a vehicle control component, wherein the vehicle control component is controlled at least in part based on the vehicle pitch.

18. The system of claim 17, wherein the vehicle control component comprises a headlight leveling component configured to level headlights based on the vehicle pitch.

19. The system of claim 17, wherein the vehicle control component comprises a suspension component.

20. The system of claim 16, further comprising:
a door status sensor configured to generate a door status;
a parking brake sensor configured to generate a parking brake status; and
an ignition state sensor configured to generate a ignition state status;
wherein the system is configured to determine an operational state of the vehicle based on the door status, parking brake status, or ignition state sensor.
